(19) United States
(12) Patent Application Publication
(10) Pub. No.: US 2022/0156295 A1
(43) Pub. Date: May 19, 2022

(54) PROFILE GENERATION DEVICE

(71) Applicant: NTT DOCOMO, INC., Chiyoda-ku (JP)

(72) Inventors: Noriaki HIROKAWA, Chiyoda-ku (JP); Yoshitaka INOUE, Chiyoda-ku (JP); Yusuke FUKAZAWA, Chiyoda-ku (JP)

(73) Assignee: NTT DOCOMO, INC., Chiyoda-ku (JP)

(21) Appl. No.: 17/599,190

(22) PCT Filed: Apr. 2, 2020
(86) PCT No.: PCT/JP2020/015221

§ 371 Date: Sep. 28, 2021

(30) Foreign Application Priority Data
Apr. 9, 2019 (JP) 2019-074037

(51) Int. Cl. G06F 16/335; G06F 16/387; G06F 16/383; G06F 16/35

(52) U.S. Cl. CPC G06F 16/337; G06F 16/35; G06F 16/383; G06F 16/387

(57) ABSTRACT

A profile generation device 10 includes the region profile estimation unit 103 configured to estimate a region profile indicating the features of a region related to a visit history of a user who has a user profile indicating the user's features on the basis of the visit history and the user profile and the user profile generation unit 107 configured to generate a user profile of a user who does not have a user profile on the basis of a visit history of the user and the region profile.

### TECHNICAL FIELD

An aspect of the present invention relates to profile generation device.

### BACKGROUND ART

Patent Literature 1 discloses a method of generating a user profile indicating attribute information such as a user's age on the basis of the user's location history acquired through a cellular phone or the like.

### CITATION LIST

### Patent Literature

[Patent Literature 1] Japanese Unexamined Patent Publication No. 2012-112372

### SUMMARY OF INVENTION

### Technical Problem

Here, as a premise, the method disclosed in Patent Literature 1 requires that there be information indicating the features of a location included in the user's location history (for example, information of each point of interest (POI)). For this reason, in a case where there is no information indicating the features of a location or a case where there is such information but the information is not substantial enough to generate a user profile, there may be concern that it is not possible to appropriately generate a user profile.

An aspect of the present invention was contrived in view of such circumstances, and an object thereof is to appropriately generate a user profile.

### Solution to Problem

According to an aspect of the present invention, there is provided a profile generation device including: a region profile estimation unit configured to estimate a region profile indicating features of a region related to a visit history of a user who has a user profile indicating the user's features on the basis of the visit history and the user profile; and a user profile generation unit configured to generate a user profile of a user who does not have the user profile on the basis of a visit history of the user and the region profile.

In such a profile generation device, the region profile of a region related to the visit history is estimated on the basis of the visit history of the user who already has a user profile and the user profile. In the profile generation device, a user profile of a new user (who does not have a user profile) is generated on the basis of a visit history of the user and the above-described region profile. In this manner, in the profile generation device, a region profile is estimated on the basis of a visit history of a certain user, and a user profile of another user is generated on the basis of the region profile and a visit history of the other user. Therefore, the user profile can be appropriately generated on the basis of the region profile regardless of the presence or absence of information indicating the features of a location visited by a user (for example, information of a POI) and the substantiality of the information. According to such a profile generation device, since the user profile can be automatically generated on the basis of a visit record (visit history) of a user, it is possible to efficiently (easily) generate a user profile, to increase the number of users who are targets for generation, and to prevent a user profile from being generated on the basis of a false declaration of a user.

### Advantageous Effects of Invention

According to an aspect of the present invention, it is possible to appropriately generate a user profile.

### BRIEF DESCRIPTION OF DRAWINGS

FIG. 1 is a diagram illustrating an outline of a profile generation device according to the present embodiment, where FIG. 1(a) is a diagram illustrating an outline of region profile estimation and FIG. 1(b) is a diagram illustrating an outline of user profile generation.

FIG. 2 is a diagram illustrating a functional configuration of the profile generation device according to the present embodiment.

FIG. 3 is a diagram schematically illustrating a user profile generation process image.

FIG. 4 is a diagram illustrating feature quantification of a user profile, where FIG. 4(a) is an example of a feature-quantified region profile, FIG. 4(b) is an example of a feature-quantified visit history of a user, and FIG. 4(c) is an example of feature-quantified information relating to the user profile.

FIG. 5 is an example of a feature-quantified user profile.

FIG. 6 is a flowchart illustrating a region profile estimation process.

FIG. 7 is a flowchart illustrating a user profile generation process.

FIG. 8 is a diagram illustrating a hardware configuration of the profile generation device.

### DESCRIPTION OF EMBODIMENTS

Hereinafter, an embodiment of the present invention will be described in detail with reference to the accompanying drawings. In the description of the drawings, the same or equivalent components are denoted by the same reference numerals and signs, and thus description thereof will not be repeated.

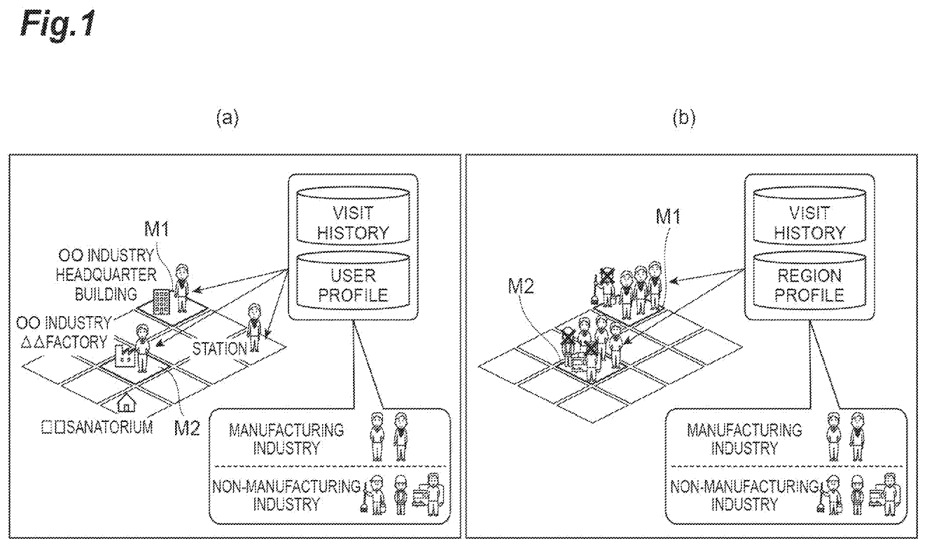

First, an outline of a profile generation device according to the present embodiment will be described with reference to FIG. 1. FIG. 1 is a diagram illustrating an outline of a profile generation device according to the present embodiment, where FIG. 1(a) is a diagram illustrating an outline of region profile estimation and FIG. 1(b) is a diagram illustrating an outline of user profile generation.

The profile generation device according to the present embodiment is, for example, a device that generates various pieces of profile information (a user profile indicating a user's features) of a user who uses a service of a communication carrier. The user profile in the present embodiment is, for example, information such as the type of industry, annual income, official position, residency, or type of employment of a user. Such a user profile is information which, unlike basic attribute information of the user (sex, age, a residential area, a service plan, a communication terminal type, a usage fee, or an amount of data communication) or information such as various applications used by the user through a service of a communication carrier, is difficult to acquire (generate) even with a method such as taking a questionnaire from a user. In the profile generation device according to the present embodiment, a visit record of a user is acquired using position information of a communication terminal (for example, base station position information) used by the user, and a user profile is created on the basis of the visit record. Such a process is based on the assumption that a visit region of the user, the type of industry of the user, and the like are closely related to each other.

Specifically, firstly, the profile generation device estimates a region profile indicating the features of a region related to a visit history of a user who already has a user profile on the basis of the visit history and the user profile. The region profile in the present embodiment is, for example, information relating to the type of industry pertaining to the region or the like. Secondly, the profile generation device generates a user profile of a user who does not have a user profile on the basis of a visit history of the user and the above-described region profile.

In the process of estimating a region profile, as shown in FIG. 1(a), a region profile in which a region of a mesh M1 and a region of a mesh M2 are regions related to the manufacturing industry is estimated on the basis of a visit history of a user in units of meshes and a user profile of the user (here, an example of the “type of industry” will be described). This is, for example, to estimate that there is a building (a headquarter building or a factory) or the like related to the manufacturing industry in the mesh M1 and the mesh M2 and to estimate that the mesh Ml and the mesh M2 are regions related to the manufacturing industry in a case where the type of industry is considered to be the manufacturing industry in a user profile of a user who has visited the mesh M1 and the mesh M2 at a predetermined time.

In addition, in the process of creating a user profile, as shown in FIG. 1(b), a user profile in which the type of industry is the manufacturing industry is generated for a user who has visited the mesh M1 and the mesh M2 which are estimated to be regions related to the manufacturing industry in the process of estimating a region profile. However, as shown in FIG. 1(b), for example, even when a user has visited the mesh M1 and the mesh M2, a region profile related to the mesh M1 and the mesh M2 may not be reflected in a user profile on the basis of attribute information, visit time, or the like of the user. In addition, for the purpose of the simplicity of description, it is described that the mesh M1 and the mesh M2 are uniquely specified (estimated) as regions related to the manufacturing industry, and that the type of industry of a user profile of a user who has visited these meshes is considered to be the manufacturing industry. However, actually, each mesh such as the mesh M1 has a probability of corresponding to each type of industry as a feature quantity, and the user profile (type of industry) of a user who has visited these meshes may be created by performing machine learning or the like.

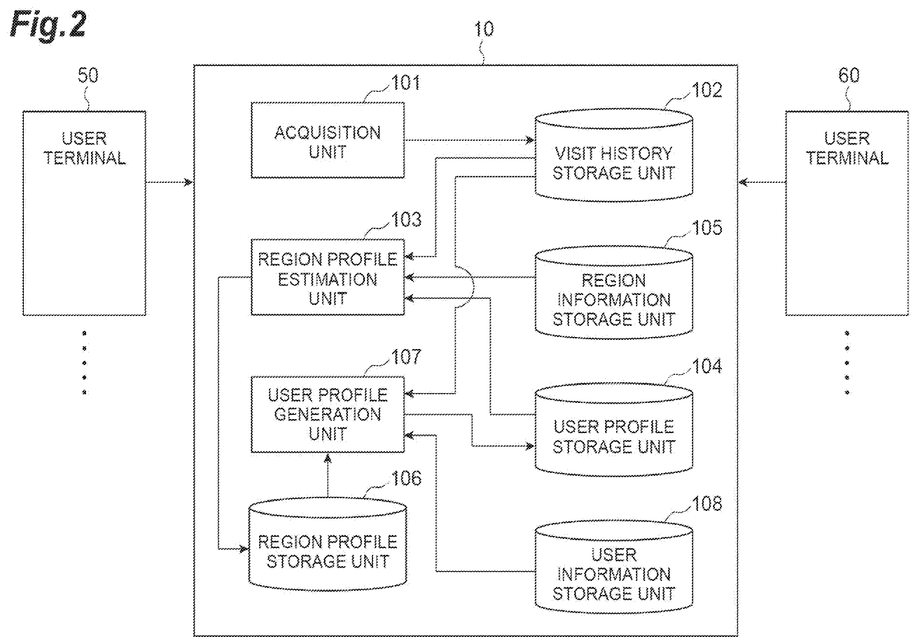

FIG. 2 is a diagram illustrating a functional configuration of a profile generation device 10 according to the present embodiment. Meanwhile, in FIG. 2, a user terminal 50 is shown as an example of a communication terminal of a user who already has a user profile, and a user terminal 60 is shown as an example of a communication terminal of a user who does not have a user profile. Although the number of each of the user terminals 50 and 60 shown in FIG. 2 is only one, the number of each is plural in reality. The user terminals 50 and 60 are only required to be communication terminals capable of performing positioning, and are, for example, smartphones, tablet-type terminals, PCs, or the like. The user terminals 50 and 60 transmit positioning results to the profile generation device 10 in a predetermined period. The positioning results include at least position information and a positioning time.

The profile generation device 10 includes an acquisition unit 101, a visit history storage unit 102, a region profile estimation unit 103, a user profile storage unit 104, a region information storage unit 105 (storage unit), a region profile storage unit 106, a user profile generation unit 107, and a user information storage unit 108.

The acquisition unit 101 acquires the positioning results from the user terminals 50 and 60. The acquisition unit 101 receives the positioning results transmitted from the user terminals 50 and 60 in a predetermined period, and stores the position information, the positioning time, and information associated with information for specifying users of the user terminals 50 and 60 related to positioning in the visit history storage unit 102.

The visit history storage unit 102 stores information such as the position information of the user terminals 50 and 60 stored from the acquisition unit 101. The visit history storage unit 102 stores the stored information each time it is stored from the acquisition unit 101, and as a result, stores visit histories (who visited when and where) of the users of the user terminals 50 and 60.

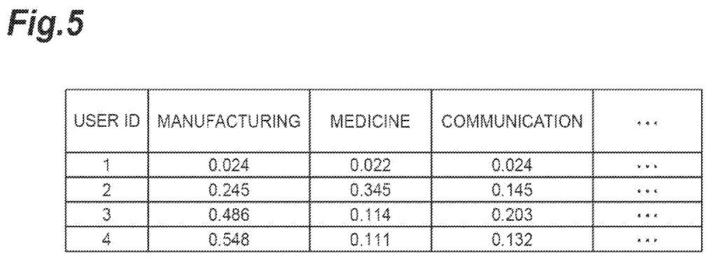

The user profile storage unit 104 stores a user profile of each user. The user profile storage unit 104 stores, for example, a user profile generated by the user profile generation unit 107. In addition, the user profile storage unit 104 may store, for example, a user profile based on content answered by a user using a questionnaire or the like. As described above, the user profile is, for example, information such as the type of industry, annual income, official position, residency, or type of employment of a user. The user profile storage unit 104 may store each of a plurality of candidate profiles constituting a user profile in association with a correct answer probability. The correct answer probability is a feature quantity indicating the plausibility of each candidate profile. For example, in an example shown in FIG. 5 (feature-quantified user profile), for each user, the correct answer probability (feature quantity) of each type of industry (candidate profile) of manufacturing, medicine, and communication is stored in association.

The region profile estimation unit 103 estimates a region profile indicating the features of a region related to a visit history of a user (that is, a user of the user terminal 50) who has a user profile indicating a user's features on the basis of the visit history and the user profile. The region profile estimation unit 103 reads (acquires) user profiles of a plurality of users which are stored in the user profile storage unit 104. In addition, the region profile estimation unit 103 reads (acquires) visit histories of the plurality of users which are stored in the visit history storage unit 102. The region profile estimation unit 103 may read only a visit history of a user who has a user profile.

For each region (mesh) of the acquired visit history, the region profile estimation unit 103 may estimate the region profile on the basis of information of a user profile that matches between users who have visited the region. Specifically, the region profile estimation unit 103 may estimate a region profile including information indicating the type of industry pertaining to a region related to a visit history of a user on the basis of the user profile information including information indicating the type of industry in which the user is engaged. For example, in a case where “type of industry: manufacturing” is included in user profiles of a plurality of users who have visited a certain region, the region profile estimation unit 103 may estimate a region profile including “type of industry: manufacturing” for the region. For each region of the acquired visit history, the region profile estimation unit 103 may estimate information of a user profile that matches at a predetermined ratio or more of all the users who have visited the region as a region profile of the region. For example, in a case where “type of industry: manufacturing” is included in a user profile of several tens % (for example, 60%) or more of all the users who have visited a certain region, the region profile estimation unit 103 may estimate a region profile including “type of industry: manufacturing” for the region.

In addition, the region profile estimation unit 103 may estimate, for example, a region profile including “type of industry: manufacturing” for a region in which the ratio of users including “type of industry: manufacturing” in a user profile is an average or more (a mesh exceeding an average between meshes). In addition, the region profile estimation unit 103 may estimate a region profile in consideration of the visit time slot in the visit history. That is, for example, in a case where “type of industry: manufacturing” is included in a user profile of several tens % or more of users who have visited a certain region during a time slot in the daytime, the region profile estimation unit 103 may estimate a region profile including “type of industry: manufacturing” for the region. Such an estimation is based on the assumption that a region visited during a time slot in the daytime which is a business time slot is more likely to be a spot related to business.

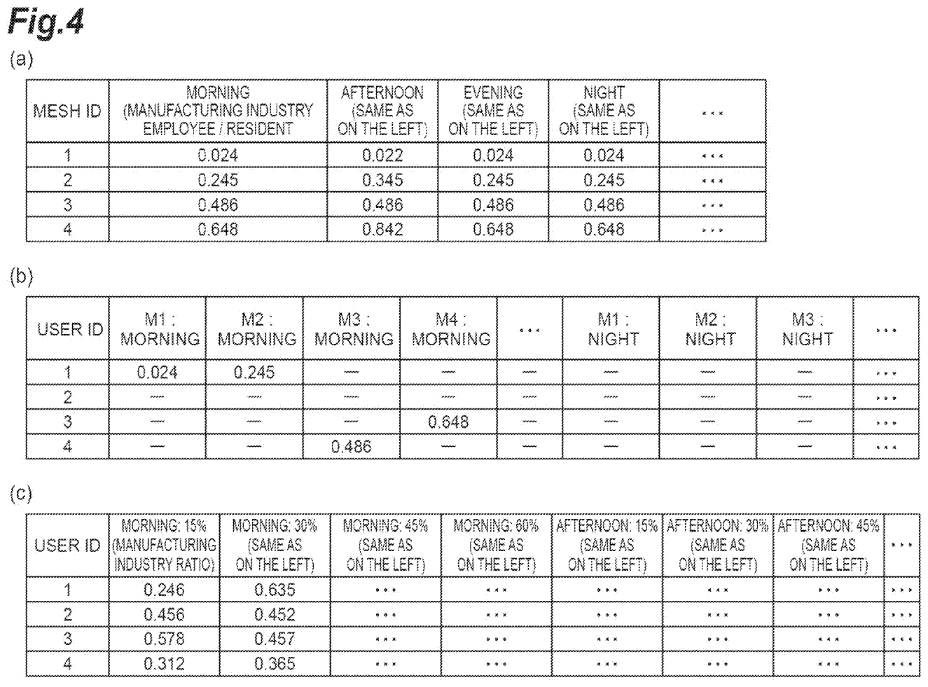

In addition, the region profile estimation unit 103 may feature-quantify a region profile. For example, as shown in FIG. 4(a), the region profile estimation unit 103 derives a region profile which is feature-quantified for “type of industry: manufacturing” in each of the morning, afternoon, evening, and night for each mesh. Specifically, the region profile estimation unit 103 derives a region profile which is feature-quantified for “type of industry: manufacturing” by dividing the number of users (employees in the manufacturing industry) including “type of industry: manufacturing” in a user profile by the number of residents. The region profile estimation unit 103 may use information stored in the region information storage unit 105, specifically, information of a POI, to confirm the validity of information of the derived (estimated) region profile and to store the estimated region profile in the region profile storage unit 106 only when it is valid.

The region profile storage unit 106 stores the region profile estimated by the region profile estimation unit 103 for each region (for each mesh). An example of the region profile stored in the region profile storage unit 106 will be described with reference to FIG. 4(a). FIG. 4(a) is a diagram illustrating an example of a feature-quantified region profile. In the example shown in FIG. 4(a), for each mesh, feature quantities (region profiles) related to the manufacturing industry in the morning, afternoon, evening, and night are associated with each other.

The user profile generation unit 107 generates a user profile of a user who does not have a user profile on the basis of a visit history of the user and the region profile. The user profile generation unit 107 reads (acquires) visit histories of a plurality of users which are stored in the visit history storage unit 102. The user profile generation unit 107 may read only a visit history of a user who does not have a user profile. In addition, the user profile generation unit 107 reads (acquires) attribute information of each user which is stored in the user information storage unit 108. The attribute information of a user is information such as the user's sex, age, residential area, service plan, communication terminal type, usage fee, or amount of data communication, and is information which is stored in the user information storage unit 108 in advance. Further, the user profile generation unit 107 reads (acquires) the region profile of each region (mesh) which is stored in the region profile storage unit 106.

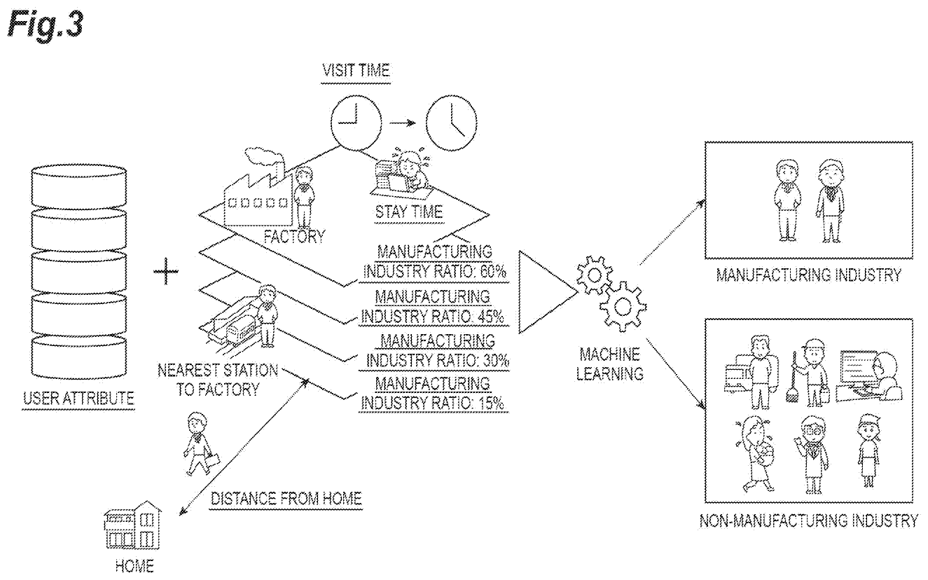

FIG. 3 is a diagram schematically illustrating a user profile generation process image. As shown in FIG. 3, the user profile generation unit 107 generates a user profile on the basis of attribute information of a user, a visit history of the user, and a region profile. The user profile generation unit 107 generates a user profile (such as, for example, “type of industry: manufacturing”) using the information as an input, for example, using an estimation model generated by machine learning (for example, a manufacturing industry employee estimation model).

The user profile generation unit 107 may acquire a visit history including a visit time to a region (mesh), and generate a user profile on the basis of a region profile in consideration of the visit time. For example, the user profile generation unit 107 generates a user profile including information indicating the type of industry (for example, manufacturing) in which a user is engaged on the basis of a region profile of a region in which the visit time to the region is a time slot in the daytime.

The user profile generation unit 107 may acquire a visit history including a stay time in a region (mesh), and generate a user profile on the basis of a region profile in consideration of the stay time. For example, the user profile generation unit 107 generates a user profile including information indicating the type of industry (for example, manufacturing) in which a user is engaged on the basis of a region profile of a region in which the stay time is long.

The user profile generation unit 107 may acquire a visit history including a distance from a region (mesh) to a home, and generate a user profile on the basis of a region profile in consideration of the distance. For example, the user profile generation unit 107 may determine that a region in which a distance from a home is extremely short is not a workplace but a home (or its surroundings), and generate a user profile including information indicating the type of industry (for example, manufacturing) in which a user is engaged on the basis of a region profile of a region other than the region (mesh).

In addition, the user profile generation unit 107 may feature-quantify a user profile. FIG. 4 is a diagram illustrating feature quantification of a user profile (type of industry: manufacturing), where FIG. 4(a) is an example of a feature-quantified region profile, FIG. 4(b) is an example of a feature-quantified visit history of a user, and FIG. 4(c) is an example of feature-quantified information relating to the user profile. On the basis of the feature-quantified region profile shown in FIG. 4(a) and a visit history of a user, the user profile generation unit 107 feature-quantifies a visit history (path) to each mesh for each user as shown in FIG. 4(b). Such feature-quantified data is generated for each of the morning, afternoon, evening, and night, for example, for meshes throughout Japan, and thus most of them are not observed (“−” in FIG. 4(b)). The user profile generation unit 107 further derives a feature quantity for each ratio (for example, 15%, 30%, 45%, and 60%) occupied by employees in the manufacturing industry for each of morning, afternoon, evening, and night instead of the unit of the mesh.

In addition, the user profile generation unit 107 may generate a plurality of candidate profiles as user profiles, and derive a correct answer probability (feature quantity) of each candidate profile. For example, in an example shown in FIG. 5 (feature-quantified user profile), for each user, the correct answer probability (feature quantity) of each type of industry (candidate profile) of manufacturing, medicine, and communication is derived.

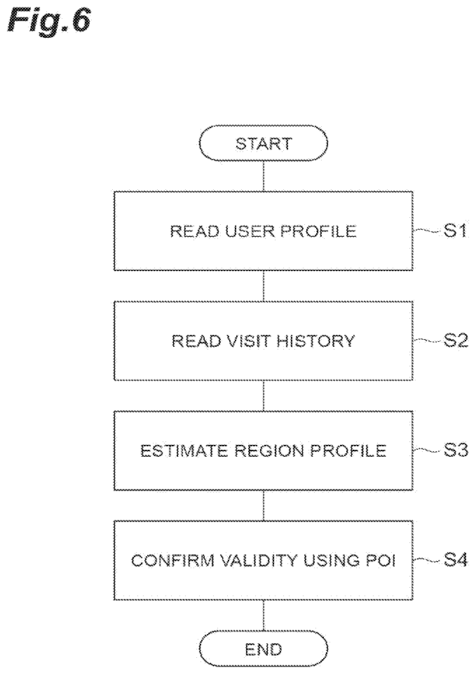

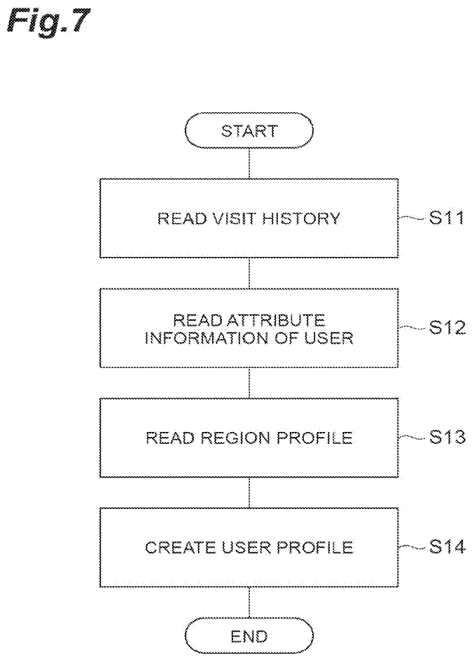

Next, processing of the profile generation device 10 will be described with reference to FIGS. 6 and 7. FIG. 6 is a flowchart illustrating a region profile estimation process. FIG. 7 is a flowchart illustrating a user profile generation process.

As shown in FIG. 6, in the region profile estimation process, the region profile estimation unit 103 of the profile generation device 10 reads a user profile of each user from the user profile storage unit 104 (step S1). Next, the region profile estimation unit 103 reads a visit history of each user from the visit history storage unit 102 (step S2).

Next, the region profile estimation unit 103 estimates a region profile indicating the features of a region related to a visit history of a user on the basis of the visit history and the user profile (step S3). Finally, the region profile estimation unit 103 reads POI information from the region information storage unit 105, confirms whether the estimated region profile is valid (whether information differs from the POI information greatly), and stores a valid region profile in the region profile storage unit 106 (step S4). The above is the region profile estimation process.

As shown in FIG. 7, in the user profile generation process, the user profile generation unit 107 of the profile generation device 10 reads the visit history of each user from the visit history storage unit 102 (step S11). Next, the user profile generation unit 107 reads the attribute information of a user from the user information storage unit 108 (step S12). Further, the user profile generation unit 107 reads the region profile from the region profile storage unit 106 (step S13).

Finally, the user profile generation unit 107 generates a user profile of a user who does not have a user profile on the basis of the visit history of the user, the region profile, and the attribute information of the user (step S14). The above is the user profile generation process.

Next, the operational effects of the present embodiment will be described.

The profile generation device 10 according to the present embodiment includes the region profile estimation unit 103 that estimates a region profile indicating the features of a region related to a visit history of a user who has a user profile indicating the user's features on the basis of the visit history and the user profile and the user profile generation unit 107 that generates a user profile of a user who does not have a user profile on the basis of a visit history of the user and the region profile.

In such a profile generation device 10, the region profile of a region related to the visit history is estimated on the basis of the visit history of the user who already has a user profile and the user profile. In the profile generation device 10, a user profile of a new user (who does not have a user profile) is generated on the basis of a visit history of the user and the above-described region profile. In this manner, in the profile generation device 10, a region profile is estimated on the basis of a visit history of a certain user, and a user profile of another user is generated on the basis of the region profile and a visit history of the other user. Therefore, the user profile can be appropriately generated on the basis of the region profile regardless of the presence or absence of information indicating the features of a location visited by a user (for example, information of a POI) and the substantiality of the information. According to such a profile generation device 10, since the user profile can be automatically generated on the basis of a visit record (visit history) of a user, it is possible to efficiently (easily) generate a user profile, to increase the number of users who are targets for generation, and to prevent a user profile from being generated on the basis of a false declaration of a user. By efficiently generating the user profile, the technical effect of reducing a processing load in a processing unit such as a CPU is also achieved.

The region profile estimation unit 103 acquires visit histories and user profiles of a plurality of users, and estimates a region profile for each region related to the visit histories on the basis of information of a user profile that matches between users who have visited the region. According to such a configuration, it is possible to estimate a region profile with a high degree of accuracy on the basis of the information of a user profile that matches between a plurality of users (information of a user profile which is considered to be strongly related to a region).

The region profile estimation unit 103 estimates a region profile including information indicating the type of industry pertaining to a region related to a visit history of a user on the basis of user profile information including information indicating the type of industry in which the user is engaged. By estimating the region profile including information indicating the type of industry, the user profile generation unit 107 can generate the user profile information including information indicating the type of industry in which the user is engaged. Thereby, it is possible to generate user profile information including information indicating the type of industry which was difficult to estimate in the past, and to further generate user profile information including an annual income or the like on the basis of the information indicating the type of industry.

The user profile generation unit 107 acquires a visit history including a visit time to a region, and generates a user profile on the basis of the region profile in consideration of the visit time. Even in the same region, whether the region is a workplace for a user, a transit point of commuting, a home, or the like differs depending on the visit time. In this regard, it is possible to more appropriately generate a user profile related to a region by considering the visit time.

The user profile generation unit 107 acquires a visit history including a stay time in a region, and generates a user profile on the basis of the region profile in consideration of the stay time. Even in the same region, whether the region is a workplace for a user, a transit point of commuting, a home, or the like differs depending on the stay time. In this regard, it is possible to more appropriately generate a user profile related to a region by considering the stay time.

The user profile generation unit 107 acquires a visit history including a distance from a region to home, and generates a user profile on the basis of the region profile in consideration of the distance. In this manner, by considering the distance from a region to a home, it is possible to determine that, for example, a region in which the distance from a home is extremely short is not a workplace or the like but a home (or its surroundings), and to more appropriately generate a user profile related to a region.

The profile generation device 10 further includes the user profile storage unit 104 that stores information generated by the user profile generation unit 107. The user profile generation unit 107 generates a plurality of candidate profiles as user profiles and derives a correct answer probability (feature quantity) of each candidate profile, and the user profile storage unit 104 stores each of the plurality of candidate profiles in association with the correct answer probability (feature quantity). Thereby, while generating user profiles of a plurality of candidates, it is possible to store the plausibility of each candidate profile, and to facilitate the utilization of the user profiles.

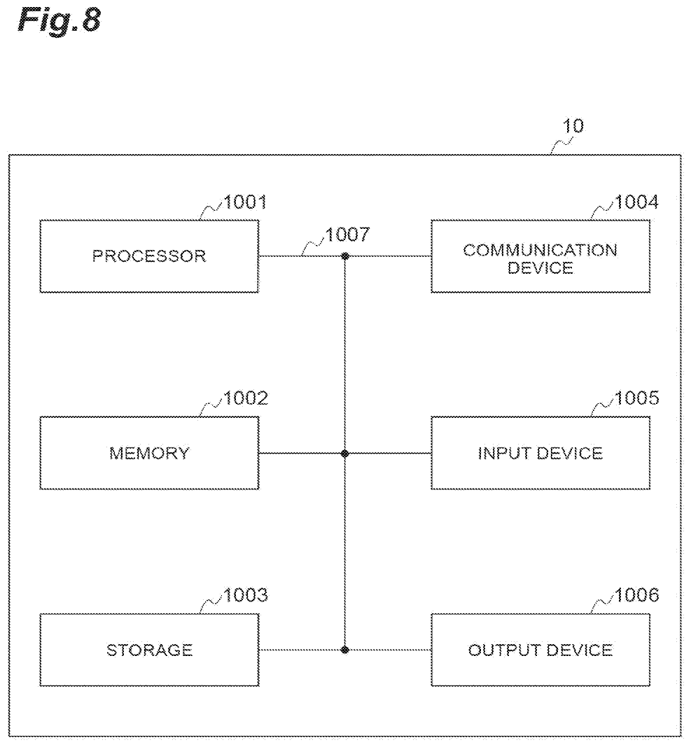

Finally, the hardware configuration of the profile generation device 10 will be described with reference to FIG. 8. The above-described profile generation device 10 may be physically configured as a computer device including a processor 1001, a memory 1002, a storage 1003, a communication device 1004, an input device 1005, an output device 1006, a bus 1007, and the like.

Meanwhile, in the following description, the word “device” may be replaced with “circuit,” “unit,” or the like. The hardware configuration of the profile generation device 10 may be configured to include one or a plurality of devices shown in the drawings, or may be configured without including some of the devices.

The processor 1001 performs an arithmetic operation by reading predetermined software (a program) on hardware such as the processor 1001 or the memory 1002, and thus each function in the profile generation device 10 is realized by controlling communication in the communication device 1004 and reading and/or writing of data in the memory 1002 and the storage 1003.

The processor 1001 controls the whole computer, for example, by operating an operating system. The processor 1001 may be constituted by a central processing unit (CPU) including an interface with a peripheral device, a control device, an arithmetic operation device, a register, and the like. For example, the control function of the user profile generation unit 107 of the profile generation device 10 or the like may be realized by the processor 1001.

In addition, the processor 1001 reads out a program (program code), a software module and data from the storage 1003 and/or the communication device 1004 into the memory 1002, and executes various types of processes in accordance therewith. An example of the program which is used is a program causing a computer to execute at least some of the operations described in the foregoing embodiment. For example, the control function of the user profile generation unit 107 of the profile generation device 10 or the like may be realized by a control program which is stored in the memory 1002 and operates in the processor 1001, and other functional blocks may be realized in the same manner. Although the execution of various types of processes by one processor 1001 has been described above, these processes may be simultaneously or sequentially executed by two or more processors 1001. One or more chips may be mounted in the processor 1001. Meanwhile, the program may be transmitted from a network through an electrical communication line.

The memory 1002 is a computer readable recording medium, and may be constituted by at least one of, for example, a read only memory (ROM), an erasable programmable ROM (EPROM), an electrically erasable programmable ROM (EEPROM), a random access memory (RANI), and the like. The memory 1002 may be referred to as a register, a cache, a main memory (main storage device), or the like. The memory 1002 can store a program (program code), a software module, or the like that can be executed in order to carry out a wireless communication method according to an embodiment of the present invention.

The storage 1003 is a computer readable recording medium, and may be constituted by at least one of, for example, an optical disc such as a compact disc ROM (CD-ROM), a hard disk drive, a flexible disk, a magneto-optic disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The foregoing storage medium may be, for example, a database including the memory 1002 and/or the storage 1003, a server, or other suitable media.

The communication device 1004 is hardware (a transmitting and receiving device) for performing communication between computers through a wired and/or wireless network, and is also referred to as, for example, a network device, a network controller, a network card, a communication module, or the like.

The input device 1005 is an input device (such as, for example, a keyboard, a mouse, a microphone, a switch, a button, or a sensor) that receives an input from the outside. The output device 1006 is an output device (such as, for example, a display, a speaker, or an LED lamp) that executes an output to the outside. Meanwhile, the input device 1005 and the output device 1006 may be an integrated component (for example, a touch panel).

In addition, respective devices such as the processor 1001 and the memory 1002 are connected to each other through the bus 1007 for communicating information. The bus 1007 may be constituted by a single bus, or may be constituted by different buses between devices.

In addition, the profile generation device 10 may be configured to include hardware such as a microprocessor, a digital signal processor (DSP), an application specific integrated circuit (ASIC), a programmable logic device (PLD), or a field programmable gate array (FPGA), or some or all of the respective functional blocks may be realized by the hardware. For example, at least one of these types of hardware may be mounted in the processor 1001.

Hereinbefore, the present embodiments have been described in detail, but it is apparent to those skilled in the art that the present embodiments should not be limited to the embodiments described in this specification. The present embodiments can be implemented as modified and changed aspects without departing from the spirit and scope of the present invention, which are determined by the description of the scope of claims. Therefore, the description of this specification is intended for illustrative explanation only, and does not impose any limited interpretation on the present embodiments.

The aspects/embodiments described in this specification may be applied to systems employing long term evolution (LTE), LTE-advanced (LTE-A), SUPER 3G, IMT-Advanced, 4G, 5G, future radio access (FRA), W-CDMA (registered trademark), GSM (registered trademark), CDMA2000, ultra-mobile broad band (UMB), IEEE 802.11 (Wi-Fi), IEEE 802.16 (WiMAX), IEEE 802.20, ultra-wide band (UWB), Bluetooth (registered trademark), or other appropriate systems and/or next-generation systems to which these systems are extended on the basis thereof.

The order of the processing sequences, the flowcharts, and the like of the aspects/embodiments described above in this specification may be changed as long as they are compatible with each other. For example, in the methods described in this specification, various steps as elements are described in an exemplary order but the methods are not limited to the described order.

The input or output information or the like may be stored in a specific location (for example, a memory) or may be managed in a management table. The input or output information or the like may be overwritten, updated, or added. The output information or the like may be deleted. The input information or the like may be transmitted to another device.

Determination may be performed using a value (0 or 1) which is expressed by one bit, may be performed using a Boolean value (true or false), or may be performed by comparison of numerical values (for example, comparison thereof with a predetermined value).

The aspects described in this specification may be used alone, may be used in combination, or may be switched during implementation thereof. In addition, notification of predetermined information (for example, notification of “X”) is not limited to explicit transmission, and may be performed by implicit transmission (for example, the notification of the predetermined information is not performed).

Regardless of whether it is called software, firmware, middleware, microcode, hardware description language, or another name, software can be widely construed to refer to commands, a command set, codes, code segments, program codes, a program, a sub-program, a software module, an application, a software application, a software package, a routine, a sub-routine, an object, an executable file, an execution thread, an order, a function, or the like.

In addition, Software, a command, and the like may be transmitted and received via a transmission medium. For example, when software is transmitted from a web site, a server, or another remote source using wired technology such as a coaxial cable, an optical fiber cable, a twisted-pair wire, or a digital subscriber line (DSL) and/or wireless technology such as infrared rays, radio waves, or microwaves, the wired technology and/or the wireless technology are included in the definition of a transmission medium.

Information, a signal or the like described in this specification may be expressed using any of various different techniques. For example, data, an instruction, a command, information, a signal, a bit, a symbol, and a chip which can be mentioned in the overall description may be expressed by a voltage, a current, an electromagnetic wave, a magnetic field or magnetic particles, an optical field or photons, or any combination thereof.

Meanwhile, the terms described in this specification and/or the terms required for understanding this specification may be substituted by terms having the same or similar meanings.

In addition, information, parameters, and the like described in this specification may be expressed as absolute values, may be expressed by values relative to a predetermined value, or may be expressed by other corresponding information.

A user terminal may also be referred to as a mobile communication terminal, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or several other appropriate terms by those skilled in the art.

The term “determining” which is used in this specification may include various types of operations. The term “determining” may include regarding operations such as, for example, calculating, computing, processing, deriving, investigating, looking up (for example, looking up in a table, a database or a separate data structure), or ascertaining as an operation such as “determining ” In addition, the term “determining” may include regarding operations such as receiving (for example, receiving information), transmitting (for example, transmitting information), input, output, or accessing (for example, accessing data in a memory) as an operation such as “determining ” In addition, the term “determining” may include regarding operations such as resolving, selecting, choosing, establishing, or comparing as an operation such as “determining ” That is, the term “determining” may include regarding some kind of operation as an operation such as “determining.”

An expression “on the basis of ˜” which is used in this specification does not refer to only “on the basis of only ˜,” unless otherwise described. In other words, the expression “on the basis of ˜” refers to both “on the basis of only ˜” and “on the basis of at least ˜.”

Any reference to elements having names such as “first” and “second” which are used in this specification does not generally limit amounts or an order of the elements. The terms can be conveniently used to distinguish two or more elements in this specification. Accordingly, reference to first and second elements does not mean that only two elements are employed or that the first element has to precede the second element in any form.

Insofar as the terms “include” and “including” and modifications thereof are used in this specification or the claims, these terms are intended to have a comprehensive meaning similarly to the term “comprising.” Further, the term “or” which is used in this specification or the claims is intended not to mean an exclusive logical sum.

In this specification, a single device is assumed to include a plurality of devices unless only one device may be present in view of the context or the technique.

In the entire disclosure, a singular form is intended to include a plural form unless the context indicates otherwise.

### REFERENCE SIGNS LIST

10 Profile generation device
103 Region profile estimation unit
104 User profile storage unit (storage unit)
107 User profile generation unit

1. A profile generation device comprising:
a region profile estimation unit configured to estimate a region profile indicating features of a region related to a visit history of a user who has a user profile indicating the user's features on the basis of the visit history and the user profile; and
a user profile generation unit configured to generate a user profile of a user who does not have the user profile on the basis of a visit history of the user and the region profile.

2. The profile generation device according to claim 1, wherein the region profile estimation unit acquires visit histories and user profiles of a plurality of users, and estimates the region profile for each region related to the visit histories on the basis of information of a user profile that matches between the users who have visited the region.

3. The profile generation device according to claim 1, wherein the region profile estimation unit estimates a region profile including information indicating a type of industry pertaining to a region related to a visit history of a user on the basis of user profile information including information indicating a type of industry in which the user is engaged.

4. The profile generation device according to claim 1, wherein the user profile generation unit acquires a visit history including a visit time to a region, and generates a user profile on the basis of the region profile in consideration of the visit time.

5. The profile generation device according to claim 1, wherein the user profile generation unit acquires a visit history including a stay time in a region, and generates a user profile on the basis of the region profile in consideration of the stay time.

6. The profile generation device according to claim 1, wherein the user profile generation unit acquires a visit history including a distance from a region to a home, and generates a user profile on the basis of the region profile in consideration of the distance.

7. The profile generation device according to claim 1, further comprising a storage unit configured to store information generated by the user profile generation unit,
wherein the user profile generation unit generates a plurality of candidate profiles as user profiles and derives a correct answer probability of each candidate profile, and
the storage unit stores each of the plurality of candidate profiles in association with the correct answer probability.
